(19) United States
(12) Patent Application Publication
(10) Pub. No.: US 2015/0163606 A1
(43) Pub. Date: Jun. 11, 2015

(54) VISUAL INDICATORS FOR A HEARING AID

(71) Applicants: Kyle Halverson, Eden Prairie, MN (US); Neil Neumann, Eden Prairie, MN (US); Mark Swenson, Eden Prairie, MN (US)

(72) Inventors: Kyle Halverson, Eden Prairie, MN (US); Neil Neumann, Eden Prairie, MN (US); Mark Swenson, Eden Prairie, MN (US)

(73) Assignee: Starkey Laboratories, Inc., Eden Prairie, MN (US)

(21) Appl. No.: 14/099,139

(22) Filed: Dec. 6, 2013

(51) Int. Cl. H04R 25/00

(52) U.S. Cl. CPC H04R 25/65

(57) ABSTRACT

Described herein are ways of providing a hearing aid wearer visual indications as to the operating status of the hearing aid. Multi-colored LEDs (light emitting diodes) are operated by the hearing aid's processing circuitry to convey light to an indicator light on the hearing aid enclosure using different colors to indicate different operating statuses. The LEDs may also be used to provide information regarding changes made to operating parameters.

### FIELD OF THE INVENTION

This invention pertains to electronic hearing aids and methods for their operation.

### BACKGROUND

Hearing aids are electronic instruments that compensate for hearing losses by amplifying sound. The electronic components of a hearing aid include a microphone for receiving ambient sound, an amplifier for amplifying the microphone signal in a manner that depends upon the frequency and amplitude of the microphone signal, a speaker for converting the amplified microphone signal to sound for the wearer, and a battery for powering the components. Digital hearing aids perform processing of the audio signal in digital domain and are typically equipped with a communications interface that enables an external programming device to configure the hearing aid for a particular wearer by adjusting particular operating parameters.

### BRIEF DESCRIPTION OF THE DRAWINGS

FIG. 1 shows the basic electronic components of an example hearing aid.

FIG. 2 shows a top view of the housing of an example hearing aid.

FIG. 3 depicts a cross-sectional view of the housing shown in FIG. 2.

FIG. 4 illustrates an embodiment where the multi-colored LED is coupled directly to the status indicator light.

FIG. 5 illustrates an embodiment where the multi-colored LED is coupled to the status indicator light by an optical fiber cable.

FIG. 6 illustrates an embodiment where the multi-colored LED is seated underneath a portion of the faceplate that is made of translucent or transparent material.

FIG. 7 illustrates an embodiment where the multi-colored LED is seated underneath a portion of the earmold that is made of translucent or transparent material.

### DETAILED DESCRIPTION

A digital hearing aid may also incorporate functionality that enables a wearer or user to change certain operating parameters without using a specialized external programming device for configuring the hearing aid. For example, the hearing aid may have one or more external buttons or switches operable by the wearer that effect particular changes in the operating behavior of the hearing aid. Hearing aids may also provide a wireless or acoustic channel by which an appropriately programmed general purpose device, such as a smart phone, may send signals to the hearing aid to cause particular changes in the hearing aid's operating parameters. In that case, there needs to be a feedback indication by which the wearer is informed what parameter changes have taken place. It would also be desirable for the hearing aid to provide the wearer with status indications such as the charge state of the battery. Described herein are ways of providing the wearer such indications using one or more multi-colored LEDs (light emitting diodes) operated by the hearing aid's processing circuitry (e.g., a controller).

Multi-colored LED(s) on a hearing device can be either internal or external to help indicate different statuses of the device. If the multi-colored LED(s) are internal, they can be displayed, for example, in two different ways. One way is by having a clear shell of the hearing device where the user can see the LED(s) through the device. Another way is to have fiber optics attached to the multi-colored LED(s) to direct the emitting light to the outer shell of the device. If the multi-colored LED(s) are external, they may be connected to the controller internally to display the proper information. The information that the multi-colored LED(s) could display may include, for example, battery power level for rechargeable or standard batteries, volume level (gain), memory environment, or self-check status. These statuses may be displayed for a pre-determined amount of time either on initial powering or changing of user controlled indicators. This would give a hearing aid user a visual way to determine the current power level of a rechargeable or standard battery, volume level (gain), memory environment, and/or self-check status before placing the hearing device into their ears. This can help the user to adjust settings or change the battery prior to placing the device in or around the ears.

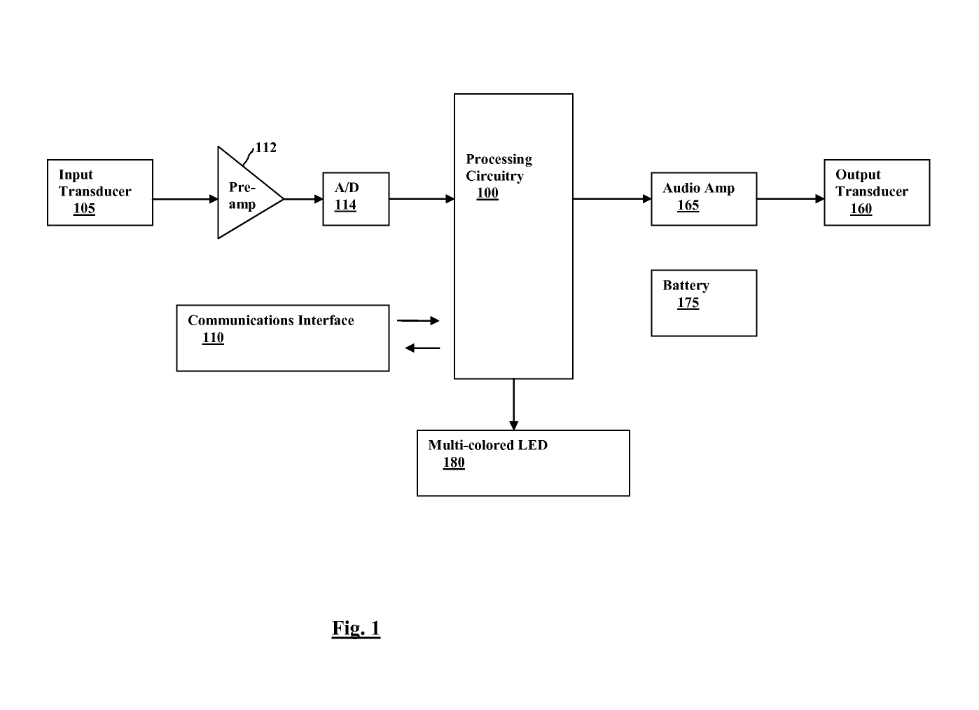

FIG. 1 illustrates the basic functional components of an example hearing aid. The electronic circuitry of a typical hearing aid is contained within a housing that is commonly either placed in the external ear canal or behind the ear. A microphone or other input transducer 105 receives sound waves from the environment and converts the sound into an input signal. After amplification by pre-amplifier 112, the input signal is sampled and digitized by A/D converter 114 to result in a digitized input signal. The device's processing circuitry 100 processes the digitized input signal into an output signal in a manner that compensates for the patient's hearing deficit. The output signal is then passed to an audio amplifier 165 that drives an output transducer 160 or receiver for converting the output signal into an audio output. A battery 175 supplies power for the electronic components.

The processing circuitry 100 may include a processor and associated memory for storing executable code and data. The overall operation of the device is determined by the programming of the processing circuitry 100, which programming may be modified via one or more communications interfaces 110 that may be, for example, a wireless transceiver or a wired port. The communications interfaces 110 could also include the processing circuitry providing an acoustic channel to receive particular tones that act to change particular operating parameters. The audio signal processing functions performed by the processing circuitry 100 may be implemented by code executed by a controller or may represent additional hardware components. Such audio signal processing functions may include: filtering and amplifying to amplifies the input signal in a frequency specific manner as defined by one or more signal processing parameters, gain control module to dynamically adjusts the amplification in accordance with the amplitude of the input signal (i.e., compression), noise reduction to perform functions such as suppression of ambient background noise and feedback cancellation, and frequency translation. The manner in which such signal processing functions are performed may be adjusted by the specification of particular parameters referred to as a signal processing parameter set. The communications interface allows input of data to a parameter modifying area of the processing circuitry memory so that parameters affecting device operation may be changed as well as retrieval of those parameters. The processing circuitry is also connected to one or more multi-colored LED(s) 180 the operation of which is controlled by a digital output from the processing circuitry. The light-emitting portions of the LED(s) 180 may be directly coupled to the hearing aid enclosure or may feed light through optical fiber to one or more indicator lights located on the hearing aid. By controlling the color and/or on-off state of the LED(s) 180, the processing circuitry is able to inform the user of particular parameter changes and/or operating status.

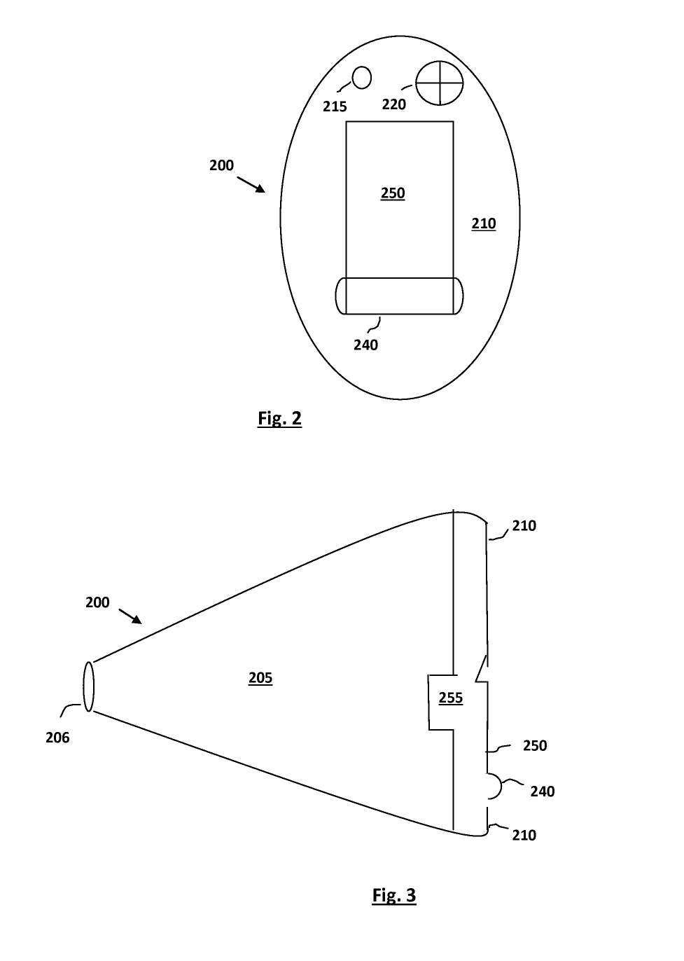

FIGS. 2 and 3 show a top view and a cross-sectional side view, respectively, of an example housing or enclosure 200 for a hearing aid. The cross-section of FIG. 3 is taken vertically through approximately the middle of FIG. 2. The enclosure is made up of an ear mold 205, within which are housed the electronic components the electronic components described above with reference to FIG. 1, and a faceplate 210. At the end of the ear mold opposite the faceplate is an outlet port 206 for the receiver to convey sound to the wearer's ear. The faceplate includes a microphone inlet port 220. Also hingedly mounted on the faceplate via hinge 240 is a battery door 250 that opens into a battery compartment 255 to allow replacement of the battery 175. The battery door may be seated underneath a portion of the faceplate via tabs or other extension to secure it in a closed position. An indentation on the faceplate may allow the user to pop the battery door open when access to the battery compartment is needed.

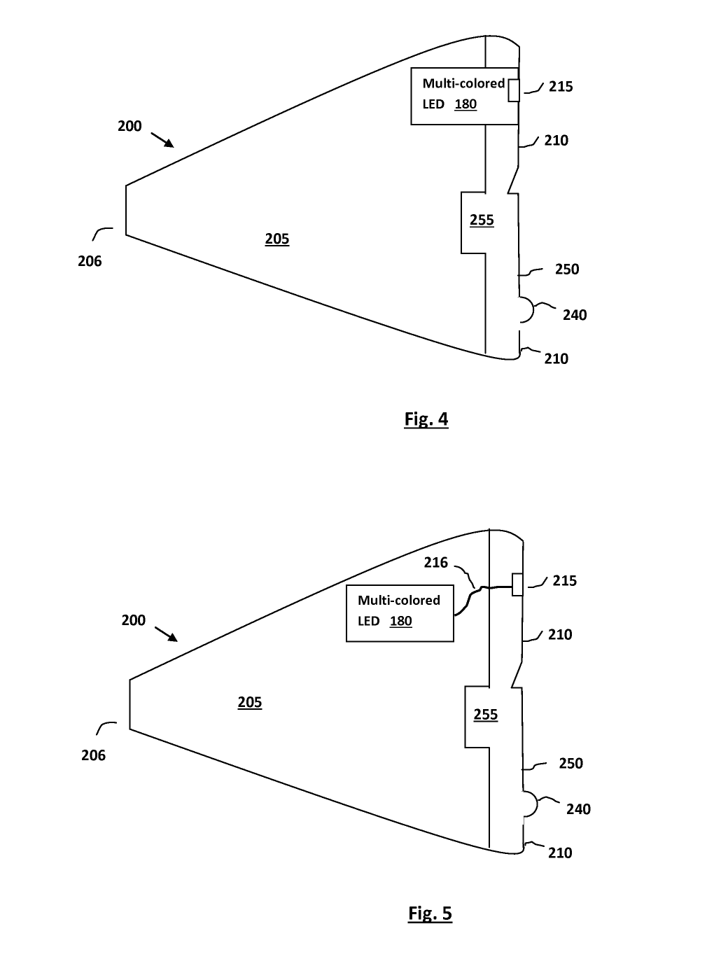

The faceplate also includes a status indicator light 215 that may be connected directly to the LED(s) 180 or connected via optical fiber. The user is thus provided with a visual indication as to parameter changes made via the communications interface and/or operating status. FIG. 4 shows a cross-sectional view of the enclosure according to one embodiment where the multi-colored LED 180 is coupled directly to the status indicator light 215. FIG. 5 shows a cross-sectional view of the enclosure according to another embodiment where the multi-colored LED 180 is coupled to the status indicator light 215 by a fiber optic cable 216.

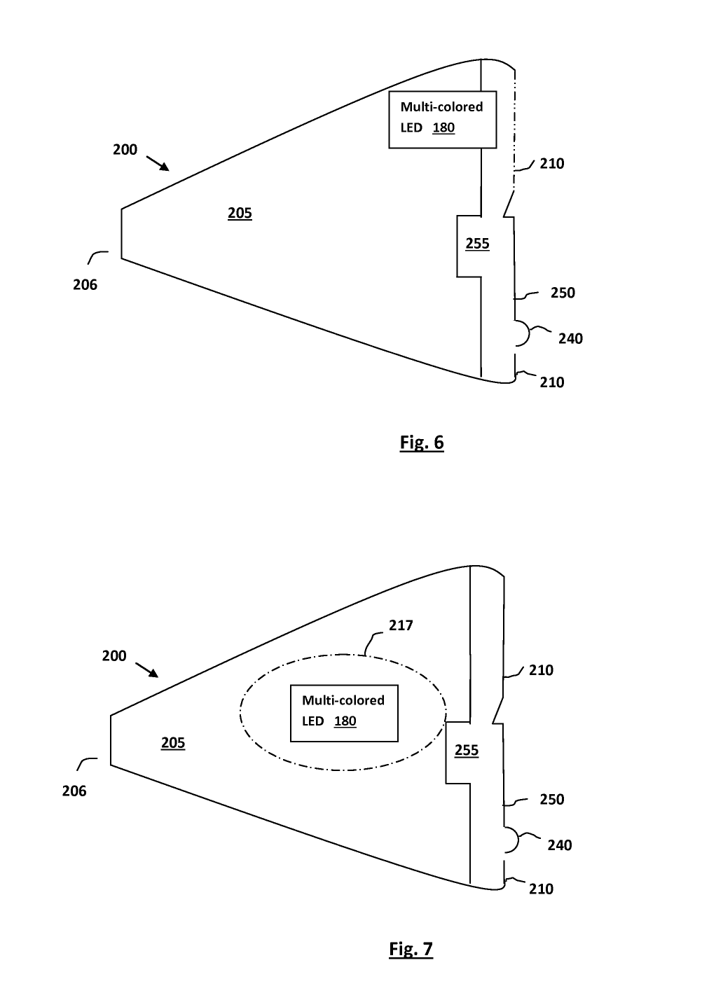

FIG. 6 shows another embodiment in which, the faceplate 210 (or a portion thereof) is constructed of transparent or translucent material. The multi-colored LED 180, rather than being coupled in to a status indicator light on the faceplate, is seated underneath the transparent or translucent faceplate so that the emitted light can be seen by a user. FIG. 7 shows another embodiment in which, the ear mold 205 (or a portion thereof) is constructed of transparent or translucent material. The multi-colored LED 180 is shown in FIG. 7 as being seated underneath a window portion 217 of the ear mold 205.

### Example Embodiments

In one embodiment, a hearing aid, comprises: an enclosure that includes a faceplate and an earmold; electronic components contained within the enclosure for receiving and outputting sound including processing circuitry; one or more multi-colored LEDs (light emitting diodes) operated by the processing circuitry, wherein the light emitted by the LED is conveyed to an indicator light on a faceplate of the enclosure; and, wherein the processing circuitry is configured to operate the LED to produce different colors that indicate to a user an operating status of the hearing aid. The processing circuitry may be further configured to operate the LED with different on-off states to indicate to a user the operating status. The indication as to operating status may include the charge of a battery for supplying power to the electronic components, a volume level or gain provided by the hearing aid, a memory environment of the processing circuitry, and/or a self-check status. The LED may coupled directly to the indicator light or coupled to an optical fiber that conveys light to the indicator light.

In another embodiment, at least a portion of the enclosure is constructed of translucent or transparent material, and the LED is seated underneath the transparent or translucent faceplate portion to allow emitted light to pass through. (A separate indicator light on the faceplate may then be omitted.) The processing circuitry may be configured to operate the LED to indicate different changes made to operating parameters for the hearing aid. The operating parameters may include parameters that determine that determine the manner in which frequency specific gain, compression, frequency translation, and/or noise reduction are performed by the hearing aid.

In one embodiment, a method for operating a hearing aid, comprises: operating one or more multi-colored LEDs (light emitting diodes) to conveyed light to an indicator light on a faceplate of an enclosure for the hearing aid; and, operating the LED to produce different colors that indicate to a user an operating status of the hearing aid. The method may further comprise operating the LED with different on-off states to indicate to a user the operating status. The indication as to operating status may include the charge of a battery for supplying power to the electronic components, a volume level or gain provided by the hearing aid, a memory environment of the processing circuitry, and/or a self-check status. The LED may be coupled directly to the indicator light, coupled to an optical fiber that conveys light to the indicator light, or seated beneath a transparent or translucent portion of the faceplate or earmold. The method may further comprise operating the LED to indicate different changes made to operating parameters for the hearing aid where the operating parameters may include parameters that determine that determine the manner in which frequency specific gain, compression, frequency translation, and/or noise reduction are performed by the hearing aid.

It is understood that variations in configurations and combinations of components may be employed without departing from the scope of the present subject matter. Hearing assistance devices may typically include an enclosure or housing, a microphone, processing electronics, and a speaker or receiver. The examples set forth herein are intended to be demonstrative and not a limiting or exhaustive depiction of variations.

The present subject matter can be used for a variety of hearing assistance devices, including but not limited to, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. Such devices are also known as receiver-in-the-canal (RIC) or receiver-in-the-ear (RITE) hearing instruments. It is understood that other hearing assistance devices not expressly stated herein may fall within the scope of the present subject matter.

This application is intended to cover adaptations or variations of the present subject matter. It is to be understood that the above description is intended to be illustrative, and not restrictive. The subject matter has been described in conjunction with the foregoing specific embodiments. It should be appreciated that those embodiments may also be combined in any manner considered to be advantageous. Also, many alternatives, variations, and modifications will be apparent to those of ordinary skill in the art. Other such alternatives, variations, and modifications are intended to fall within the scope of the following appended claims.

What is claimed is:

1. A hearing aid, comprising:
an enclosure that includes an ear mold and a faceplate;
electronic components contained within the enclosure for receiving and outputting sound including processing circuitry;
one or more multi-colored LEDs (light emitting diodes) operated by the processing circuitry, wherein the light emitted by the LED is conveyed to an indicator light on a faceplate of the enclosure; and,
wherein the processing circuitry is configured to operate the LED to produce different colors that indicate to a user an operating status of the hearing aid.

2. The hearing aid of claim 1 wherein the processing circuitry is configured to operate the LED with different on-off states to indicate to a user the operating status.

3. The hearing aid of claim 1 wherein the indication as to operating status includes the charge of a battery for supplying power to the electronic components.

4. The hearing aid of claim 1 wherein the indication as to operating status includes a volume level or gain provided by the hearing aid.

5. The hearing aid of claim 1 wherein the indication as to operating status includes a memory environment of the processing circuitry.

6. The hearing aid of claim 1 wherein the indication as to operating status includes a self-check status.

7. The hearing aid of claim 1 wherein the LED is coupled directly to the indicator light.

8. The hearing aid of claim 1 wherein the LED is coupled to an optical fiber that conveys light to the indicator light.

9. The hearing aid of claim 1 wherein at least a portion of the enclosure is constructed of translucent or transparent material and wherein the LED is seated underneath the transparent or translucent faceplate portion to allow emitted light to pass through.

10. The hearing aid of claim 1 wherein the processing circuitry is configured to operate the LED to indicate different changes made to operating parameters for the hearing aid.

11. A method for operating a hearing aid, comprising:
operating one or more multi-colored LEDs (light emitting diodes) to conveyed light to an indicator light on a faceplate of an enclosure for the hearing aid; and,
operating the LED to produce different colors that indicate to a user an operating status of the hearing aid.

12. The method of claim 11 further comprising operating the LED with different on-off states to indicate to a user the operating status.

13. The method of claim 11 wherein the indication as to operating status includes the charge of a battery for supplying power to the electronic components.

14. The method of claim 11 wherein the indication as to operating status includes a volume level or gain provided by the hearing aid.

15. The method of claim 11 wherein the indication as to operating status includes a memory environment of the processing circuitry.

16. The method of claim 11 wherein the indication as to operating status includes a self-check status.

17. The method of claim 11 wherein the LED is coupled directly to the indicator light.

18. The method of claim 11 wherein the LED is coupled to an optical fiber that conveys light to the indicator light.

19. The method of claim 11 wherein at least a portion of the enclosure is constructed of translucent or transparent material and wherein the LED is seated underneath the transparent or translucent faceplate portion to allow emitted light to pass through.

20. The method of claim 11 further comprising operating the LED to indicate different changes made to operating parameters for the hearing aid.
